(19) United States
(12) Patent Application Publication
(10) Pub. No.: US 2011/0258053 A1
(43) Pub. Date: Oct. 20, 2011

(54) BILLING METHOD FOR ONLINE ADVERTISING, SYSTEM THEREOF, AND COMPUTER-READABLE RECORDING MEDIUM

(75) Inventors: Youn Sik Lee, Seoul (KR); Dong Wook Kim, Seongnam-si (KR); Jung Soo Ha, Yongin-si (KR); Yu Won Kim, Seongnam-si (KR)

(73) Assignee: NHN BUSINESS PLATFORM CORPORATION, Seongnam-si (KR)

(21) Appl. No.: 13/062,671

(22) PCT Filed: Sep. 8, 2009
(86) PCT No.: PCT/KR2009/005088

§ 371 Date: Apr. 4, 2011

(30) Foreign Application Priority Data
Sep. 8, 2008 (KR) 10-2008-0088464

(51) Int. Cl. G06Q 30/00

(52) U.S. Cl. 705/14.69

(57) ABSTRACT

Provided are a method for billing for an online advertisement, a system thereof and a computer-readable recording medium. The method for billing for an online advertisement includes: extracting an advertisement publication result based on a selection history of a plurality of users for advertisement information of an advertiser; providing the advertisement publication result to the advertiser; receiving basic self-billing information for determining an billing object from an advertiser terminal; performing the billing for an published online advertisement based on the received basic self-billing information.

### TECHNICAL FIELD

The present invention relates to a method for billing for an online advertisement, a system thereof and a computer-readable recording medium, and more particularly, to a method for transmitting basic billing information to an advertiser terminal and performing billing based on information on invalidity of advertisement selection when the information on invalidity of advertisement selection is received from the advertiser terminal receiving the basic billing information, a system thereof and a computer-readable recording medium.

### BACKGROUND ART

Among several methods of billing an advertiser for an advertisement provided on online, a cost per click (CPC) billing model has been most widely used. In the CPC model, billing is performed according to click counts of a user for provided advertisement listings.

However, the billing is not performed for all of provided advertisements, and a process of excluding invalid click counts from objected click counts (OCCs) is generally performed. Calculation of the invalid click counts may be used as an effective means for preventing abusing in a keyword search advertisement. The detection of the invalid click is performed by a search advertisement providing system providing a search advertisement. An invalid click detecting process performed by the search advertisement providing system is not published to the advertiser. This is the reason that the publication of an invalid click detecting algorithm causes vulnerability for abusing.

Due to non-publication of the invalid click detecting process, the advertiser may doubt whether the click counts presented as a base of the billing in an advertisement system are properly calculated. For example, the advertiser may doubt whether a calculation reference of the click counts operated in the advertisement system is proper. Alternatively, the advertiser may doubt whether the click counts by unfair click meaninglessly consuming his advertisement cost is included in the click counts provided from the advertisement system. Furthermore, in spite of the data providing and publicity of the advertisement system proving that the click counts, which are the base of the billing, are calculated by a proper calculation reference in the advertisement system, it is insufficient in getting rid of immanent dissatisfaction or dispute of the advertiser.

Therefore, the demand for an advertisement billing technology providing a supplementary measure for the problem to allow an advertiser and/or an advertisement system operator not to be confronted by an unexpected situation and capable of being sufficiently trusted by both of the advertisement system providing an advertisement service and the advertiser requesting the advertisement has been increased.

### DISCLOSURE

### Technical Problem

An object of the present invention is to solve the above-mentioned problems according to the related art.

Another object of the present invention is to reduce uncertainty in advertisement budget execution by allowing an advertiser to refer to basic billing information on an already published advertisement and then input information capable of having an influence on publication of the advertisement.

Another object of the present invention is to reduce an effort made by an advertisement system operator in order to detect unfair click.

Another object of the present invention is to allow an advertiser to sufficiently trust click counts, which is a base of billing.

### Technical Solution

A characteristic configuration of the present invention for accomplishing the objects of the present invention and advantageous effects of the present invention described below is as follows.

According to an aspect of the present invention, there is provided a method for billing an advertiser for an advertisement provided on a network, the method including: extracting basic billing information based on based on a selection history of a plurality of users for advertisement information of the advertiser; transmitting the basic billing information to a system of the advertiser; receiving information on invalidity of advertisement selection from the advertiser terminal; determining a billing amount based on the received information on invalidity of advertisement selection; and performing billing for the advertiser by applying the determined billing amount.

According to an embodiment of the present invention, there is provided a method including: extracting an advertisement publication result based on a selection history of a plurality of users for advertisement information of an advertiser; providing the advertisement publication result to the advertiser; receiving basic self-billing information for determining an billing object from an advertiser terminal; performing the billing for an published online advertisement based on the received basic self-billing information.

In addition, when the published online advertisement is provided in consideration of a bid amount input by the advertiser, both of the bid amount input prior to publication of the advertisement and the basic self-billing information input after publication of the advertisement may be taken into consideration in performing the billing for the online advertisement.

The basic self-billing information input by the advertiser terminal may be data for determining the billing object for the corresponding online advertisement. For example, with respect to a CPC billing model based advertisement, the advertiser may input information for determining billing object click counts for which he is to pay among the total observed click counts. For example, the advertiser receiving the total observed click counts as the advertisement publication result may determine his cost expense range by inputting valid click counts.

In addition, the basic self-billing information (valid click counts, invalid click counts, a valid click ratio, etc.) input by the advertiser may be reflected in a quality index of the corresponding advertisement. The quality index may be calculated as an index representing a ratio of expectation about the corresponding advertisement to customer attraction degree. The quality index may be reflected in calculating a ranking index for a future advertisement exposure.

According to another aspect of the present invention, there is provided a system for billing an advertiser for an advertisement provided on a network, the system including: a billing setting unit extracting basic billing information based on a selection history of a plurality of users for advertisement information of the advertiser and transmitting the basic billing information to a system of the advertiser; and a billing determining unit determining a billing amount based on information on invalidity of advertisement selection received from the advertiser terminal.

In addition, there are provided other methods, other systems, and a computer-readable recording medium having a computer program recorded therein, the computer program executing the methods.

### Advantageous Effects

Effects of the present invention accomplished through a characteristic configuration of the present invention are as follows:

According to the present invention, predictability of the advertiser about the advertisement cost, etc., is increased, thereby making it possible to efficiently publish the advertisement.

According to the present invention, the effort made by the advertisement system operator in order to detect the invalid (unfair) click may be reduced.

### DESCRIPTION OF DRAWINGS

FIG. 1 is a diagram showing a schematic configuration of an advertisement system according to an embodiment of the present invention;

FIG. 2 is a diagram showing a specific configuration of a billing processing unit according to an embodiment of the present invention;

FIG. 3 is a graph illustratively showing a appropriate billing reference set by a billing reference setting unit according to an embodiment of the present invention;

FIG. 4 is a diagram showing a participating aspect of subjects participating in an advertisement service method according to an embodiment of the present invention;

FIG. 5 is an illustrative diagram showing an interface provided to an advertiser through an advertiser terminal according to an embodiment of the present invention;

FIG. 6 is an operational flowchart describing an advertisement service method of an advertisement system according to an embodiment of the present invention; and

FIGS. 7 to 9 are tables showing a ranking index each calculated using click counts of keywords.

### DESCRIPTION FOR KEY ELEMENTS IN THE DRAWINGS

100: ADVERTISEMENT SYSTEM
110: SEARCH ENGINE
120: ADVERTISEMENT REGISTERING UNIT
130: ADVERTISEMENT PROVIDING UNIT
140: ADVERTISEMENT SELECTION INFORMATION PROCESSING UNIT
150: BILLING PROCESSING NIT
151: BILLING REFERENCE SETTING UNIT
152: BILLING SETTING UNIT
153: ADVERTISER INTERFACE UNIT
154: BILLING DETERMINING UNIT
155: PAYMENT PROCESSING UNIT
160: CONTROLLING UNIT
170: COMMUNICATING UNIT
180: DATABASE MANAGING UNIT
180A: CONTENTS DATABASE
180B: ADVERTISEMENT DATABASE
180C: LOG DATABASE
190: EXPOSURE ATTRIBUTE ADJUSTING UNIT

### BEST MODE

Exemplary embodiments of the present invention will be described in detail with reference to the accompanying drawings These exemplary embodiments will be described in detail for those skilled in the art in order to practice the present invention. It should be understood that various embodiments of the present invention are different but do not have to be exclusive. For example, specific shapes, configurations, and characteristics described in an embodiment of the present invention may be implemented by another embodiment without departing from the spirit and the scope of the present invention. In addition, it should be understood that position and arrangement of individual components in each disclosed embodiment may be changed without departing from the spirit and the scope of the present invention. Therefore, the detailed description described below should not be construed as a restrictive meaning. The scope of the present invention is limited only by the accompanying claims and their equivalents, if they are appropriately described. The similar reference numerals will be used to describe the same or similar function throughout the accompanying drawing.

Hereinafter, exemplary embodiments of the present invention will be described in detail with reference to the accompanying drawings so that those skilled in the art may easily practice the present invention.

### Exemplary Embodiments of the Present Invention

In the present description, billing means processing for generating billing data including a billing procedure, a billing amount, basic billing data, or the like, for imposing a cost to an advertiser as a price for publishing or exposing an advertisement for the advertiser. Particularly, the billing described in the present description should be understood as a widest sense including all of billing schemes according to various aspects including a CPC scheme of calculating an advertisement cost according to selection counts of users for the advertisement (for example, click counts of the user for advertisement information on an advertisement list published for search advertisement).

Configuration of Entire System

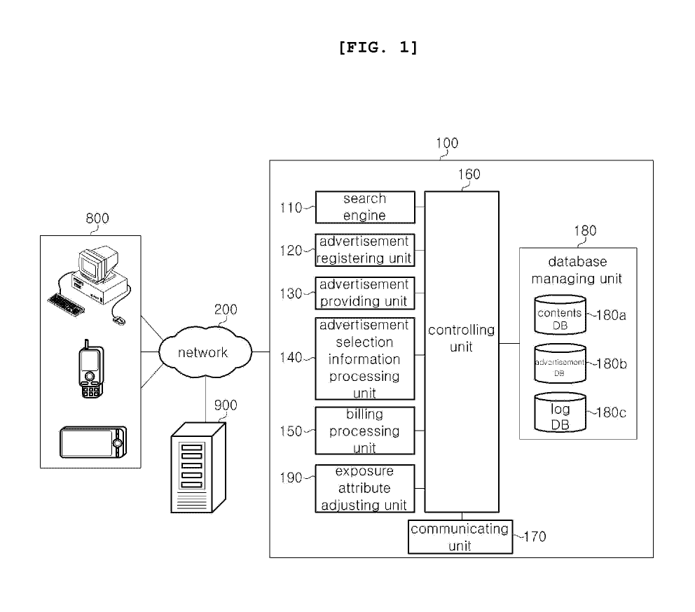

FIG. 1 is a diagram showing a schematic configuration of an advertisement system 100 according to an embodiment of the present invention.

Referring to FIG. 1, an advertisement service according to an embodiment of the present invention may be performed an advertisement system 100 performing the advertisement service, a user terminal 800 enabling internet users to be connected to an internet, and an advertiser terminal 900 receiving information related to billing from the advertisement system 100 and transferring inputs of an advertiser for the corresponding billing to the advertisement system 100.

The user terminal 800 may be various digital devices providing an internet connection function to internet users wanting internet surfing The internet users may search and inquire various products, services, and/or information while performing the internet surfing on the internet through the user terminal 800, and be connected to the advertisement system 100 or a publishing system (not shown) associated with the advertisement system 100 to view various advertisements provided on the internet by the advertisement system 100 or the publishing system. In addition, the internet users may select (for example, click) the various advertisements provided on the internet to be connected to a cyber space of an internet address linked to the corresponding advertisement, thereby making it possible to purchase various products, which are objects of the corresponding advertisement.

The advertiser terminal 900 may be various digital devices capable of performing communication with the advertisement system 100 so as to receive information related to the billing from the advertisement system 100 and transfer inputs of the advertiser for the corresponding billing to the advertisement system 100. The advertiser terminal 900 may also be replaced by the user terminal 800. However, the present invention is not limited thereto. That is, the user terminal 800 should be necessarily capable of being connected to the advertisement system 100 or the publishing system associated with the advertising system 100 through a public network called the internet. To the contrary, the advertiser terminal 900 may be connected to the advertisement system 100 through a communication network capable of performing communication with the advertisement system 100 rather than being limited to the internet. However, the advertiser terminal 900 may preferably provide an internet connection function. Furthermore, the advertiser terminal 900 may be various digital devices capable of performing communication with the advertisement system 100 so that the advertisers wanting the advertisement on the internet may be connected to the advertisement system 100 to request the advertisement and use the advertisement service provided from the advertisement system 100, or a system in which the various digital devices are linked and operated.

Therefore, the user terminal 800 and the advertiser terminal 900 may be implemented as one or more digital devices including a memory unit and having a microprocessor mounted therein to include operational capability, such as a personal computer (for example, a desktop computer, a notebook computer, a tablet computer, a palmtop computer, etc.), a workstation, a personal digital assistance (PDA), a web pad, a cellular phone, etc., or a system configured of one or more digital devices.

Here, a communication network 200 is a network supporting the communication among the advertisement system 100, the user terminal 800, and the advertiser terminal 900 shown in FIG. 1. A configuration of a base communication technology configuring the communication network 200 does not have an essential influence on implementation of the present invention. The communication network 200 may be configured regardless of an aspect of the communication such as wired communication, wireless communication, and the like. The communication network 200 may also be configured based on any kind of communication technology enabling information to be exchanged among the advertisement system 100, the user terminal 800, and the advertiser terminal 900. In addition, various known technologies for reliability and security of an information exchange process may be applied to the communication network 200.

The advertisement system 100 may receive information on providing conditions of the advertisement from the advertiser through a communication device, for example, the advertiser terminal 900. However, the present invention is not limited thereto. That is, the information on the providing conditions of the advertisement may also be input by the advertiser through a communication device other than the advertiser terminal 900, and the advertiser terminal 900 may be implemented to be used only for receiving information related to the billing from the advertisement system 100 and transferring the input of the advertiser for the corresponding billing to the advertisement system 100.

The advertisement system 100 may receive a keyword related to the corresponding advertisement, targeting information for the user to which the advertisement is exposed, information on limitation of advertisement exposure, title and description (T&D) information of the advertisement to be provided to the user, and the like, from the advertiser, prior to providing the advertisement to the user terminal 800. This information input through the advertiser terminal 900 may be utilized as an exposure reference of the advertisement as in a bid-based search keyword advertisement according to the related art. In addition, a bit amount (BA) may be input as base data of position arrangement among a plurality of advertisements for the corresponding keyword search and/or calculation of an advertisement billing amount. The bit amount input by the advertiser prior to advertisement publication may be used for calculating an advertisement publication cost together with information (counts of valid clicks of observed click counts) on invalidity of the click input by the advertiser after the advertisement publication.

When the advertiser may autonomously determine billing object click counts after the advertisement publication as described above, a burden on detection of invalid clicks of an advertisement system operation may be reduced. In addition, an undesired cost may not be paid for sudden increase in the click counts due to social issues, etc., that is not correlated with sales and is not useful for the advertiser.

Meanwhile, there may be no need to input the bid amount (BA) for the advertisement to be published in the future in an advertisement service method according to an embodiment of the present invention. In the bid scheme search keyword advertisement according to the related art, the bit amount of the advertiser is used as a reference of determination of exposure ranking between the plurality of advertisements for the corresponding keyword and calculation of the billing amount per click for the exposed advertisement. However, in the advertisement service method according to an embodiment of the present invention, the determination of the exposure ranking and the calculation of the advertisement billing may also be performed based on basic self-billing information (information on invalidity of the click) such as ‘valid click counts’ or ‘invalid click counts’ by the advertiser input after the advertisement publication in a state in which the bid amount set prior to the advertisement publication is not taken into consideration. The basic self-billing information is selection information of the advertiser autonomously selecting validity or invalidity with respect to the click counts included in basic billing information provided from the advertisement system 100.

The advertisement system 100 may provide the advertisement to the user terminal 800. Here, providing the advertisement includes exposing the corresponding advertisement on an internet space so that the internet users visiting the internet space through the user terminal 800 may view the corresponding advertisement through, for example, web browsing of the user terminal 800 or providing the corresponding advertisement according to the request of the user terminal 800.

A form of providing the advertisement of the user terminal 800 does not have an essential influence on implementation of the advertisement service method according to an embodiment of the present invention. The advertisement service method having various forms such as a search keyword advertisement through matching between a search keyword and an advertiser specifying keyword, a contextual advertisement provided while being included in contents provided to the user terminal 800, a banner advertisement to which regional targeting information is applied, and the like may be used for embodiments of the present invention. An online advertisement according to the related art such as the search keyword advertisement, the contextual advertisement, a targeting option for advertisement, and the like, is obvious to those skilled in the art. Therefore, a detailed description thereof will be omitted.

The advertisement system 100 may perform a contents service (for example, an online search service and a news providing service) accompanied by the providing of the advertisement. However, a separate publishing system is involved in the providing of the advertisement according to an embodiment of the present invention to provide the contents service, thereby making it possible to entice the user.

As described above, although not shown in FIG. 1, the separate publishing system may be involved in the providing of the advertisement according to an embodiment of the present invention.

For example, when the user terminal 800 visits any search site to input a query, a search advertisement related to the corresponding query may be provided to a search result page provided to the user terminal 800.

This search advertisement may be provided in a form included in the search result page by the advertisement system 100; however, all of functions related to configuring the search result page should not be supported by the advertisement system 100.

The system providing the search result page as a response to the query input in the user terminal 800 may be a search engine system separately configured from the advertisement system 100. The advertisement system 100 may receive an advertisement providing request from the search engine system and provide the advertisement related to the query input in the user terminal 800 in a form included in the search result page.

In the above-mentioned advertisement providing form, the search engine system forms the page publishing the advertisement. Therefore, it may be called a publishing system for the corresponding advertisement.

A news site providing system, a blog hosting system, and the like, which are other examples of the publishing system, may provide the advertisement to the user terminal 800 through communication with the advertisement system 100 according to an embodiment of the present invention.

In this case, the publishing system providing contents such as news articles or blog posting to the user terminal 800 may request the advertisement system 100 for the providing of the advertisement related to the contents. In response to this request, the advertisement system 100 may provide the advertisement information to be provided to the user terminal 800 through a partial region of a contents providing page.

That is, the contents and the advertisement to be provided to the user terminal 800 may be controlled through a single contents providing page by different systems. With respect to matching between the contents and the advertisement, technologies related to the known contextual advertisement and keyword advertisement may be used. The advertisement matching is obvious to those skilled in the art. Therefore, a detailed description thereof will be omitted.

Meanwhile, when the publishing system intervenes in the providing of the advertisement, history information on reaction (click, etc.) of the user for the provided advertisement may be collected by the publishing system and transferred to the advertisement system 100, or may be collected directly by the advertisement system 100.

The advertisement system 100 may provide information on an advertisement publication result to the advertiser terminal 900.

With respect to the providing of the advertisement according to an embodiment of the present invention, the cost for the advertisement publication may be calculated by the basic self-billing information by the advertiser, for example, valid click count setting or invalid click count setting, after the advertisement publication. That is, the advertiser may have right to present click counts for which he is to pay as the “valid click counts” according to his judgment with respect to for an already published advertisement. Alternately, the advertiser may have right to present click counts for which he is not to pay as the “invalid click counts” according to his judgment with respect to the already published advertisement.

The advertisement system 100 may provide advertisement publication result information on the published advertisement in order to assist in allowing the advertiser to present the valid click counts or the invalid click counts. For example, various indices such as the exposure counts of the published advertisement, the observed click counts (OCCs), the click counts for each time interval, the click counts for each advertisement providing region, and the like, may be provided as auxiliary data in setting the ‘valid click counts’ or the ‘invalid click counts’ of the advertiser.

In addition, the advertisement system 100 may provide an interface for determining the click counts, that is, the valid click counts, judged that there is a valid advertisement effect among the observed click counts of the published advertisement through the advertiser terminal 900. The advertiser may refer to log information in click unit on the advertisement publication and recognize the valid click counts excluding clicks corresponding to a predetermined condition (for example, clicks from specific internet protocol (IP)s, clicks in specific time zones, clicks repeated at a predetermined cycle, and the like), through the interface.

The advertiser may judge the click counts for which he is to pay based on the ‘advertisement publication result information’ provided by the advertisement system 100 and transfer the click counts for which he is to pay as the ‘valid click counts’ for the corresponding advertisement to the advertisement system 100. Alternatively, the advertiser may judge the click counts for which he is not to pay based on the ‘advertisement publication result information’ provided by the advertisement system 100 and transfer the click counts for which he is not to pay as the ‘invalid click counts’ for the corresponding advertisement to the advertisement system 100.

The advertiser may input the ‘valid click counts’ or the ‘invalid click counts’ for each unit in which the advertisement is published. When the advertisements in keyword unit are published, the advertiser may input different ‘valid click counts’ or ‘invalid click counts’ for each of the advertisements published in keyword unit. In addition, when the advertisements in time unit are published, the advertiser may input different ‘valid click counts’ or ‘invalid click counts’ for each published time zone for the same keyword.

For example, when the advertiser registers an advertisement for the keyword such as flower delivery, flower basket, memorial day, etc., to provide the advertisement through the advertisement system 100, even in the case in which the observed click counts for the keyword ‘flower delivery’ is the same that of the keyword ‘memorial day’, the ‘valid click counts’ or the ‘invalid click counts’ for each keyword may be differently presented.

In addition, the advertiser may specify a time interval of the advertisement publication to input the ‘valid click counts’ or the ‘invalid click counts’. For example, when there are several advertisers publishing an advertisement for the keyword ‘flower delivery’, some advertisers may input the ‘valid click counts’ or the ‘invalid click count’ on a weekly basis, and others may input them on a monthly basis. As such, the advertisement system 100 allow the advertiser to set a payment object period when he inputs the ‘valid click counts’ or the ‘invalid click count’, thereby making it possible to provide a higher degree of freedom about payment time of an advertisement publication cost. It is possible to force a cyclic payment time limit.

As such, the basic self-billing information transferred from the advertiser terminal 900 to the advertisement system 100 may include identification information on an object advertisement, the ‘valid click counts’ or the ‘invalid click counts’, and information for a payment object advertisement publication period. Information to be included in the basic self-billing information may be variously changed according to the configuration of the advertisement system 100. For example, the advertiser may input the total click counts including the ‘valid click counts’ or the ‘invalid click counts’ for the payment object advertisement, or may input a ‘valid billing amount’ or an ‘invalid billing amount’ for the ‘valid click counts’ or the ‘invalid click counts’ as selection information when a unit cost per click is previously set to a predetermined value.

The advertisement system 100 may perform the billing for the already published advertisement based on the basic self-billing information of the advertiser received from the advertiser terminal 900.

The billing for the search keyword advertisement based on the CPC model according to the related art is performed based on click information of the users for the advertisement exposure and the bid amount input by the advertiser prior to the advertisement exposure. The billing for the search keyword advertisement may be performed by maintaining account information for the advertiser in a database and reflecting the final billing amount determined according to the advertisement exposure and the click of the users in advertiser account information.

Similarly, in the advertisement service method according to an embodiment of the present invention, the advertisement system 100 may perform the billing for the advertisement publication cost by store account information related to the advertiser in a database and changing balance information of the advertiser account after the advertisement publication. In the CPC search keyword advertisement according to the related art, the billing object click counts are calculated by applying an invalid click detection process to reaction information (the observed click counts) for the advertisement from the users. To the contrary, according to an embodiment of the present invention, the billing object click counts may be determined by basic billing click count information (capable of being input as the valid/invalid click counts, etc.) input by the advertiser after the advertisement publication. When the process of determining the billing object click counts is used, the advertisement system 100 may not perform a complicated invalid click detection process.

As an example, the advertiser publishing the advertisement for a plurality of keywords with respect to the same product selling page for two months from November may receive statistical information on the providing of the advertisement for two months. According to the received statistical information, the observed click counts in November are 3,000 and the observed click counts in December are 4,000. However, when sales in November is higher than those in December in spite of increase in the observed click counts in December (when the keyword replaced in early December increases only the click counts unrelated to the sales), the advertiser may set 2,800 as the ‘valid click counts’ for the advertisement publication in November and set 2,500 as the ‘valid click counts’ for the advertisement publication in December. In this case, the ‘valid click counts means the click counts for which the advertiser is to pay for the entire campaign about the advertisement object product selling page rather than keyword unit. The advertisement system 100 may reduce the advertisement publication cost in the advertiser account based on the ‘valid click counts’ input by the advertiser and the bid amount previously input by the advertiser. However, only the ‘valid click counts’ input by the advertiser and the ‘bid amount’ input prior to the advertisement publication are not all factors of determining the billing amount. An additional billing amount correcting process may be applied.

As another example, when the advertiser publishing the banner advertisement receives the exposure counts of the banner and the click counts for the banner from the advertisement system 100 and input 30,000 as the ‘valid click counts’ for a week during which the banner advertisement is published, the advertisement system 100 may reduce the balance of the advertiser account by 120 dollars (the cost per click is 0.04 dollar) to thereby perform the billing for the corresponding banner advertisement.

As in the above-mentioned example, the advertisement system 100 may entirely trust the ‘valid click counts’ or the ‘invalid click counts’ from the advertiser and reflect the ‘valid click counts’ or the ‘invalid click counts’ in actual billing information. As such, when the billing is performed based on the basic self-billing information (capable of being input in a form such as the valid click counts, the invalid click counts, etc.) from the advertiser, uncertainty in the CPC based search keyword advertisement billing according to the related art (for example, based on opacity of invalid/unfair click judgment) may be removed.

Meanwhile, in the advertisement publication in keyword unit, the advertisement system 100 may set a limitation in the ‘valid click counts’ or the ‘invalid click counts’ which the advertiser may set based on previous advertisement publication result information of the advertiser. That is, an input range of the basic self-billing information input by the advertiser may be limited based on the history information for the previous advertisement publication. In addition, according to an embodiment of the present invention, since the final advertisement billing amount may be determined by the advertisement system 100, even in the case in which the input of the basic self-billing information from the advertiser is not specifically limited, the history information of the advertisement publication may be reflected in a correction process for determining the final advertisement billing amount.

As an example, the advertisement system 100 may calculate an expected billing amount based on the advertisement publication result information of the corresponding advertiser and set a settable range of the ‘valid click counts’ or the ‘invalid click counts’ to which the expected billing amount belongs, thereby making it possible to reduce the uncertainty in the advertisement billing. The expected billing amount may be calculated based on a weighted moving average of the previous advertisement execution budget, and a weight according to the passage of time may be taken into consideration in the calculation process. The weight may be designed so that a repetitive pattern is reflected therein for each season and for each day of week or recently executed budge has a more influence thereon.

As another example, a limitation may also be applied in a form in which a rapid change of a predetermined level or more based on the last executed advertisement budget scale is not allowed.

In applying the limitation for the setting of the ‘valid click counts’ or the ‘invalid click counts’ described above, the input itself of the ‘valid click counts’ or the ‘invalid click counts’ that do not satisfy the corresponding condition may not be allowed. In addition, the input of the ‘valid click counts’ or the ‘invalid click counts’ violating the limitation condition is allowed; however, an operation may also be flexibly made by performing a separate approval procedure.

The advertisement system 100 may control attributes of future advertisement exposure based on the ‘valid click counts’ or the ‘invalid click counts’ (the basic self-billing information) of the advertiser received from the advertiser terminal 900.

For example, a case in which the advertisement is published and billed in the keyword unit on a weekly basis is assumed. After the week during which the corresponding advertisement is published is passed, the advertisement system 100 provides the publication result for the advertisement of the advertiser related to the corresponding keyword. The advertiser inputs the ‘valid click counts’ or the ‘invalid click counts’ for which he is to pay for the corresponding keyword advertisement for the last advertisement publication week based on the advertisement publication result information. The total billing amount (the billing amount may be adjusted through an exception treatment process) is reduced in the advertiser account based on the ‘valid click counts’ or the ‘invalid click counts’ input by the advertiser. When the advertiser wants to continuously publish the advertisement for the same keyword in next week, the ranking index for the corresponding keyword advertisement may be adjusted based on the click counts according to the ‘valid click counts’ or the ‘invalid click counts for the last advertisement publication week.

The ranking index described above may be represented by the following Equation 1 and Equation 2.

Ranking Index (RI)=Valid Click Counts/Expected Click Counts (ECC) [Equation 1]

Expected Click Counts=Expected Click Ratio According To Advertisement Exposure Aspect×Click Counts Of User For Advertisement Generated During Previous Exposure. [Equation 2]

Here, the expected click ration is an expected click rate.

The ranking index by above Equation 1 may be appreciated as an index for expecting the unit cost per click in the future advertisement exposure. The advertisements are arranged based on this ranking index, thereby making it possible to expect that the billing amount for the future advertisement publication will be maximized.

For example, the ranking index may be calculated by a function based on the sales expected that the corresponding advertisement will generate against the advertisement publication. That is, the ranking index in proportion to the expected total sales rather than the expected unit cost per click may be applied.

As such, the ranking index may be calculated through various expected indices related to the sales for the advertisement to be exposed in the future, and the weight according to time may be applied to the previous advertisement publication result taken into consideration in calculating the expected index.

The above-mentioned ranking index is only an example, and various ranking indices may be introduced in order to optimize the future sale cost according to the advertisement publication based on the basic self-billing information such as the ‘valid click counts’ or the ‘invalid click counts’ input by the advertiser.

These ranking indices may be configured of indices for the advertisement publication results, and may be calculated without taking into consideration of a quality index in which relation between the advertisement and the advertisement exposure page, etc., is reflected. An index for suitability of a title and description (T&D) of the advertisement, quality of a product service sold through the advertisement, etc., that is, the quality index may also be taken into consideration in the ranking index. However, an embodiment of the present invention may sufficiently be implemented only through the calculation of the ranking index in one form in which the quality index is excluded in order to remove uncertainty, etc., in a process of calculating the quality index, which may be problematic in the relationship with the advertiser.

According to an embodiment of the present invention, the advertisement system 100 may also receive information on the plurality of keywords for which the advertiser wants to publish the advertisement, when it receives the request for providing the advertisement from the advertiser terminal 900. For example, when the advertiser is a flower delivery service enterprise, the plurality of keywords may be “flower delivery”, “flower basket”, “memorial day”, “congratulatory gift”, etc.

In this case, the advertisement system 100 may publish the advertisement information for exposing a web page, etc., of the advertiser on the product selling page when the user of the user terminal 800 inputs any one of the keywords. According to another embodiment of the present invention, the advertisement system 100 itself may also define the search keyword for publishing the advertisement information of the advertiser in consideration of business types, scales, advertisement budget, etc., of the advertiser requesting for providing the advertisement.

The advertisement provided by the advertisement system 100 may be provided to the user terminal 800 through the web page controlled by the advertisement system or the web page controlled by a separate publisher system (not shown).

The advertisement system 100 may include a search engine 110, an advertisement registering unit 120, an advertisement providing unit 130, an advertisement selection information processing unit 140, a billing processing unit 150, an exposure attribute adjusting unit 190, a controlling unit 160, a communicating unit 170, and a database managing unit 180. Although each of the components configuring the advertisement system 100 is shown as being implemented in a single device in FIG. 1, the present invention is not limited thereto. Each of the components may be implemented as mutually separated systems to perform desired data processing through communication therebetween.

According to an embodiment of the present invention, it may be appreciated that at least some of the search engine 110, the advertisement registering unit 120, the advertisement providing unit 130, the advertisement selection information processing unit 140, the billing processing unit 150, the controlling unit 160, the communicating unit 170, and the database managing unit 180 indicate program modules communicating with the user terminal 800 and/or the advertiser terminal 900 and/or physical devices executing these program modules. These program modules may be included as an operating system, an application program module and other program module in the advertisement system 100, and be physically stored in several known storage devices. In addition, these program modules may also be stored in a remote storage device capable of communicating with the advertisement system 100. Meanwhile, these program modules includes routines, sub-routines, program, objects, components, data structures, etc., performing specific tasks described below or executing specific abstraction data types according to an embodiment of the present invention, without being limited thereto.

The advertisement system 100 according to an embodiment of the present invention may communicate with the user terminal 800 and/or the advertiser terminal 900 through the communication network, register and publish the advertisement according to the request from the advertiser terminal 900, and bill the advertiser for the advertisement when the advertisement is provided to the user terminal 800 according to selection of the user.

Meanwhile, the advertisement system 100 according to an embodiment of the present invention may be included in an operating server of an internet portal site performing a search advertisement, a display advertisement, etc.

The search engine 110 according to an embodiment of the present invention may serve to crawl a web document (herein, the web document generally indicates data such as a text, an image, a moving picture, an audio, etc., and digital data formed by combining at least two of them) stored in a remote computer connected to the communication network, store information on the crawled web document in a contents database 180a described below, and then provide the web document to the user according to the request of the user terminal 800.

The advertisement registering unit 120 according to an embodiment of the present invention may serve to store data such as a text, an image, a moving picture, an audio, etc., specified and/or selected by the advertiser according to the request of the advertiser terminal 900 and an advertisement formed by combining at least two of them as advertisement data in an advertisement database 180b described below. In addition, the advertisement registering unit 120 may provide a predetermined interface such as the known online advertisement bid tool to the advertiser terminal 900 in order to register the advertisement. In a general keyword search advertisement, functions supporting the bid by the advertiser may be provided by the advertisement registering unit 120. The advertisement registering unit 120 may store information on advertisement registration of the advertiser through communication with the data base managing unit 180 in a necessary range.

The advertisement providing unit 130 according to an embodiment of the present invention may serve to receive the user input such as a search keyword, etc., input in the search engine 110, search advertisement data corresponding to the user input from the advertisement database 180b, and insert the advertisement information (for example, an uniform resource locator (URL) of a web page including the advertisement data or a single line advertisement message, or the like) representing at least a portion of the searched advertisement data into the web document to be provided to the user. Here, the advertisement providing unit 130 may also insert a program code allowing the user terminal 800 to be directly connected to the advertiser terminal 900 into the web document when the user specifies the advertisement by an action, etc., of selecting the advertisement information inserted into the web document.

The advertisement providing unit 130 may provide an advertisement in a form such as a banner advertisement as well as a response for the search result. In addition, as described above, when the separate publishing system is involved in the providing of the advertisement, the advertisement providing unit need not to configure all contents provided to the user terminal, and may perform only a control function for the advertisement listing provided as a portion of the search result.

When an event in which the internet user specifies a portion of the advertisement information provided to him using a mouse, a keyboard, or an input device performing a similar function occurs, the advertisement selection information processing unit 140 according to an embodiment of the present invention may serve to store recording for the event in a log database 180c described below.

When the separate publishing system is intervened, the advertisement selection processing unit 140 of the advertisement system 100 may directly collect the reaction information on the advertisement provided to the user or receive the user reaction (selection) information collected by the publishing system through a separate communication protocol.

The billing processing unit 150 according to an embodiment of the present invention may serve to bill the advertiser registering the advertisement information provided to the user terminal 800 for a predetermine cost when the advertisement information is specified by the user. According to an embodiment of the present invention, the billing processing unit 150 may use a cost per click (CPC) scheme in which the billing is performed when the click for the advertisement is generated or a cost per sale (CPS) scheme in which the billing is performed so that the advertisement cost is paid according to the sales.

As described above, the bid amount input by the advertiser, the information on the valid click counts input by the advertiser, the quality index of the advertisement, the previous advertisement publishing information, etc., may be used to determine the total advertisement billing amount. The billing processing unit calculates the total billing amount and updates the calculated total billing amount in the advertiser account information, thereby performing the billing for the published advertisement.

The exposure attribute adjusting unit 190 according to an embodiment of the present invention may adjust the exposure attributes of the online advertisement related to the advertiser in consideration of the basic self-billing information such as the ‘valid click counts’ or the ‘invalid click counts’ input by the advertiser. That is, the exposure attribute adjusting unit 190 may calculate the ranking index to be in proportion to the click counts or the total billing amount determined using the basic self-billing information such as the ‘valid click counts’ or the ‘invalid click counts’ input by the advertiser after the advertisement publication, and arrange and provide the advertisements to be exposed in the future according to the calculate ranking index. The ranking index may also be calculated through various expected indices related to the sales for the advertisement to be exposed in the future.

The ranking index calculated by the exposure attribute adjusting unit 190, the advertisement exposure ranking based the ranking index, etc., may be stored in and managed by the database 180b. The advertisement providing unit 130 may refer the stored ranking index and exposure ranking to use them as an arrangement reference for the advertisement to be published in the future.

Meanwhile, the online advertisement may be managed in keyword unit or campaign unit, and may have identification information provided thereto according to the management unit to be stored in the database 180b. Each of the components configuring the advertisement system 100 may refer to desired information using the identification information.

Meanwhile, the advertisement exposure attributes adjusted by the exposure attribute adjusting unit 190 are not limited to the advertisement exposure ranking and the ranking index, which is the reference of the advertisement exposure ranking. The attributes about display itself of the advertisement information transferred through the search result page, for example, advertisement exposure attributes for providing specific advertisement information in a form differentiated from other advertisements for the same keyword, such as a display font, a size of the font, a color change in a background region, etc., may also be controlled by the exposure attribute adjusting unit 190.

The ranking index becomes higher as the basic self-billing information such as the ‘valid click counts’ or the ‘invalid click counts’ input by the advertiser is processed as higher click counts. Therefore, when the basic self-billing information such as the ‘valid click counts’ or the ‘invalid click counts’ of the corresponding advertisement among several advertisements is processed as a relatively low click counts as compared to other advertisements in the keyword according to the advertisement publication result, the corresponding advertisement may be more likely to be excluded from a predefined exposure ranking.

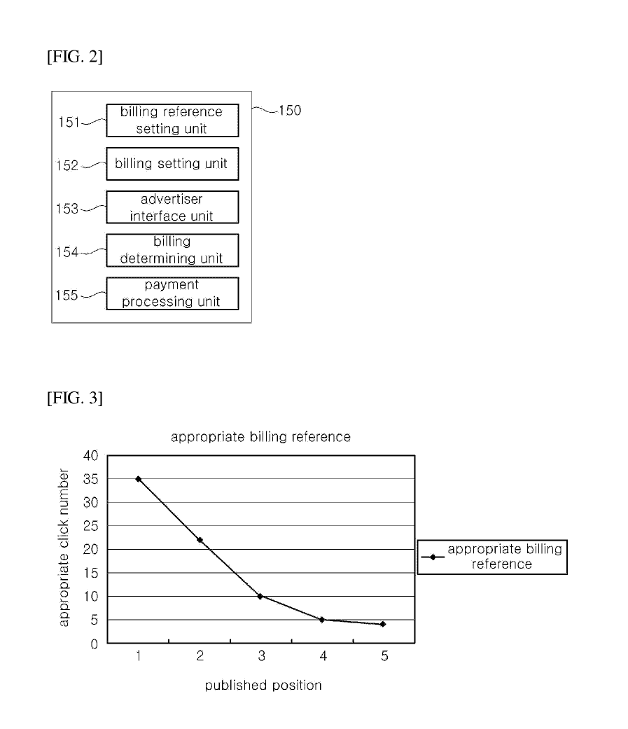

FIG. 2 is a diagram showing a specific configuration of a billing processing unit 150 according to an embodiment of the present invention.

Referring to FIG. 2, the billing processing unit 150 according to an embodiment of the present invention may include a billing reference setting unit 151, a billing setting unit 152, an advertiser interface unit 153, a billing determining unit 154, and a payment processing unit 155.

The billing reference setting unit 151 according to an embodiment of the present invention serves to set an appropriate billing reference for the advertisement information registered according to a predetermined reference such as an advertisement product, a search keyword, a search type, etc., based on the selection history (for example, the click counts for specific advertisement information) of the user for the advertisement information stored the log database 180c. A method for setting the billing reference will be described below.

The billing setting unit 152 according to an embodiment of the present invention may serve to aggregate the selection history for the advertisement information stored in the log database 180c to extract the basic billing information. According to an embodiment of the present invention, the basic billing information may include the click counts of the user for the corresponding advertisement information, the advertisement cost per click, the log data according to the click of the user, etc. In addition, the basic billing information may also include a basic billing amount, which is a value obtained by multiplying the click counts of the user by the advertisement cost per click.

The advertiser interface unit 153 according to an embodiment of the present invention may transfer an interface to the advertiser terminal 900, wherein the interface may provide the basic billing information and/or the information on the selection history for the advertisement information stored in the log database 180c to the advertiser terminal 900 and allow the advertiser to input the information (the basic self-billing information) on invalidity of the advertisement selection. Here, the information on the invalidity of the advertisement selection input by the advertiser may be represented as a format of the count or the ratio of valid or invalid clicks of the entire clicks for predetermined advertisement information or a billing amount according to the clicks, etc. In addition, the information on the invalidity of the advertisement selection may be represented as a format of specifying a specific internet protocol (IP), requesting exclusion of clicks in a specific time zone, or requesting exclusion of specific selection information.

The billing determining unit 154 according to an embodiment of the present invention may compare the billing amount according to the information on the invalidity of the advertisement selection input by the advertiser with the basic billing amount calculated by the billing setting unit 152 to thereby adjust the billing amount for the corresponding advertiser.

The billing determining unit 154 may also adjust the billing amount by entirely trusting the information on the invalidity of the advertisement selection input by the advertiser according to the advertiser or without conditions. A method for adjusting the billing amount by the billing determining unit 154 will be described below.

The payment processing unit 155 according to an embodiment of the present invention may provide an interface allowing the advertiser to pay the cost required for the advertisement to the advertiser terminal 900. However, the present invention is not limited thereto. The payment processing unit 155 may be selectively implemented and be thus omitted. The controlling unit 160 according to an embodiment of the present invention serves to control data flow among the search engine 110, the advertisement registering unit 120, the advertisement providing unit 130, the advertisement selection information processing unit 140, the billing processing unit 150, the communicating unit 170, and the database managing unit 180.

The communicating unit 170 according to an embodiment of the present invention serves to allow the advertisement system 100 according to an embodiment of the present invention to communicate with external devices such as the user terminal 800, the advertiser terminal 900, and the like.

The database managing unit 180 according to an embodiment of the present invention may include the contents database 180a in which the information on the web document crawled by the search engine 110 is stored, the advertisement database 180b in which the data for the advertisement registered by the advertiser is stored, the log database 180c in which the selection history of the user for the advertisement information is stored, etc.

For example, the contents database 180a may include the identification information of the web document, the collection data of the web document, the title of the web document, the abstract information of the web document, the attribute information of the web document, etc. Here, the attribute information of the web document, which is information representing the attributes of each of the web documents stored in the contents database 180a, may include, for example, the identifier of the advertisement information in which each of the web documents are combined, the kind of the advertisement, the main keyword, etc. According to an embodiment of the present invention, when the search engine 110 crawls the web document and then analyzes it to extract the information such as the main text, etc., the attribute information of the corresponding web document may be determined based on the extracted information.

The advertisement database 180b may include the identification information of the advertisement, the identification information of the advertiser, the information on a publication period of the advertisement, the billing amount per click of the advertisement, the advertisement information to be combined with the web document, etc. The advertisement information to be combined with the web document may include the URL representing the advertiser terminal 900 or the single line advertisement message, as described above.

The log database 180c may store the identification information of the advertisement selected by the user, identification information of the user selecting the advertisement and/or the identification information of the user terminal 800, the time information at which the advertisement is selected, the identification information of the web document into which the advertisement is inserted, etc.

Although the database storing the information for implementing the present invention has been classified into three databases, that is, the contents database 180a, the advertisement database 180b, and the log database 180c in the above-mentioned embodiment, a configuration of the database including this classification may be changed by those skilled in the art as needed.

Finally, in the present invention, the database includes a database in a broad sense including computer file system based data recording, etc., as well as a database in a narrow sense. It should be appreciated that the database described in the present invention may include a set of simple operational processing logs if it may be searched to extract a predetermined data.

Billing Policy

Before a detailed description about several billing methods according to the present invention, for the sake of convenient explanation, a case where an advertisement system 100 according to an embodiment of the present invention performs billing will be assumed based on a CPC model billing policy commonly used in a current search advertisement field. However, the present invention is not limited thereto, and may also be applied to a CPS type.

Therefore, the advertisement system 100 is capable of providing a web document including at least one advertisement area to a user terminal 800, in response to search and inquiry requests by a user. Each advertisement area may include one or more pieces of advertisement information. In addition, the advertisement information included in each advertisement area may be disposed in the advertisement area by a predetermined rule. In this case, advertisement costs may be differentiated according to the position at which the advertisement information is disposed. For example, a case where the advertisement cost is generally set more highly in the advertisement positioned in the higher advertisement area, as compared with the advertisement positioned in the relatively lower advertisement area. Different advertisement costs may be billed for even the advertisements disposed in the same position of the same advertisement area according to an attribute of the web page linked to the corresponding advertisement. For example, a higher advertisement cost may be billed for an advertisement inserted in a web document corresponding to a search keyword which a user searches frequently.

Hereafter, a method by which the advertisement system 100 bills an advertiser for advertisement will be described in detail, according to a preferred embodiment of the present invention.

1. Generation of Billing Reference Data

As described above, a billing reference setting unit 151 according to an embodiment of the present invention may set an appropriate billing reference for a predetermined advertisement. A method by which the billing reference setting unit 151 sets an appropriate billing reference for the advertisement may be variously assumed.

According to the embodiment of the present invention, the billing reference setting unit 151 may calculate an average user click count during a recent predetermined period or specific time zone, such as the last one month, the last six months, the last one week, or a specific period, with respect to the advertisements disposed in each advertisement area, based on a log database 180c, and then set the appropriate billing reference based on the calculated average user click count.

According to the embodiment of the present invention, the average user click count calculated by the billing reference setting unit 151 may be an average click count of users with respect to advertisement information at each advertisement publication position, regardless of the attribute of a web document with which the advertisement information is to be combined. For example, a case where the average click count during the last one month is calculated with respect to an advertisement at the second position of an advertisement area A may be assumed. This average click count may be calculated with respect to an advertisement at each advertisement publication position of each advertisement area.

According to another embodiment of the present invention, each average user click count calculated by the billing reference setting unit 151 may be separately calculated according to attribute information of the web document with which advertisement is to be combined. The attribute information of the web document may be obtained from main text, image, or the like extracted from the web document. When the web document is provided to the user based on a search keyword inputted into a search engine 110 by the user, the corresponding keyword may be treated as the attribute information of the web document. For example, a case where the average click count during the last one month is calculated with respect to the advertisement at the second position of the advertisement area A of the web document treating a keyword “golf” as the attribute information may be assumed. This average click count may be calculated with respect to advertisement at each position of each advertisement area in reference to the attribute information of the web document.

The billing reference setting unit 151, in order to set the above-described billing reference, may receive a keyword related to the corresponding advertisement, targeting information for a user to which the advertisement is exposed, information on restriction of advertisement exposure, information on title and description (T&D) of the advertisements be provided to the user, or the like, from the advertiser. For example, this information inputted by the advertiser through an advertiser terminal 900 may be utilized as an exposure reference of the advertisement, as in a bid-based search keyword advertisement of the related art.

A bid amount (BA) for the advertisement to be published in the future may not need to be inputted in an advertisement service method according to an embodiment of the present invention. In a bid type keyword advertisement of the related art, the bid amount of the advertiser is utilized as a reference for deciding exposure rankings among a plurality of advertisements with respect to the corresponding keyword and calculating a billing amount per click with respect to the exposed advertisements. However, in the advertisement service method according to the embodiment of the present invention, determining the exposure rankings and calculating the billing amount with respect to the exposed advertisements may be performed based on selection information such as ‘a valid click count” or “an invalid click count”, which is inputted by the advertiser after publishing of advertisement.

FIG. 3 is a graph illustrating the appropriate billing reference set by the billing reference setting unit 151 according to the embodiment of the present invention.

More specially, in FIG. 3, a horizontal axis represents advertisement insertion positions of advertisements included in a specific advertisement area and a vertical axis represents appropriate click counts (that is, appropriate billing references) during a predetermined period.

Referring to FIG. 3, it shows that an appropriate click count of the advertisement inserted at the first position of the advertisement area is set to 35, and an appropriate click count of the advertisement inserted at the second position of the advertisement area is set to 22.

The appropriate click count in FIG. 3 is shown to have a specific value (for example, 35, 22, or the like), but according to another embodiment of the present invention, the appropriate click count may be set in the form of a section composed of the lowest limit and the highest limit (for example, 33 to 37, 20 to 24, and so on).

Further, FIG. 3 shows that the graph in reference to the appropriate click counts has a down and right form in which the appropriate click count falls as an insertion rank of advertisement is lowered. However, this is only for one example, and there may exit various forms of graphs.

Meanwhile, FIG. 3 illustrates that the vertical axis of the graph represents the click counts, but the billing reference according to the present invention need not to be limited by the click counts. Anything that is usable as an index for determining whether the billing is appropriate or not, for example, the billing amount billed to the advertiser, may be used as the billing reference according to the present invention.

2. Extraction of Basic Billing Information

A billing setting unit 152 according to an embodiment of the present invention may count a selection story of advertisement information stored in a log database 180c to extract basic billing information such basic billing amounts, or the like. This basic billing information may be provided as advertisement publication result information for published advertisement in order to aid to present a valid click count or an invalid click count of the advertiser.

For example, if the total click count of users within a predetermined period is 100 and the cost billed to the advertiser per click of corresponding advertisement information is 100 won, the basic billing amount would be 10,000 won. This basic billing amount may be calculated with respect to each advertisement.

As described above, log data on selection of advertisement information by the user, or the like, besides the basic billing amount, may be considered and extracted as basic billing information.

For example, the basic billing information may include various indexes such as an exposure count, an observed click count (OCC), a click count by periods, a click count by advertisement supply areas, and the like, with respect to published advertisement.

In addition, the basic billing information may include log information of each click unit with respect to advertisement publication and the count of clicks except clicks corresponding to a predetermined condition (for example, clicks from a specific IP, clicks at a specific time zone, clicks repeated on a predetermined period, or the like).

3. Input of Information on Invalidity of Selection of the Advertisement

According to an embodiment of the present invention, the basic billing information calculated by the billing setting unit 152 may be provided to the advertiser through an advertiser terminal 900 as advertisement publication result information on published advertisement in order to aid to present a valid click count or an invalid click count of the advertiser.

In addition to the advertisement publication result information, an interface for guessing the count of clicks determined to be effectively subject to advertisement influence, that is, a valid click count among the observed click counts of published advertisements, may be provided to an advertiser terminal 900 from the advertisement system 100.

The advertiser may point out the invalidity of selection of the advertisement of the user in various manners based on the basic billing information transmitted from the advertisement system 100.

For example, the advertiser may refer to log information of each click unit with respect to advertisement publication, or grasp the count of valid clicks except clicks corresponding to a predetermined condition (for example, clicks from a specific IP, clicks at a specific time zone, clicks repeated on a predetermined period, or the like), through the interface provided from the advertisement system 100.

The advertiser may determine the count of clicks for which the advertiser will pay based on ‘advertisement publication result information’ provided by the advertisement system 100, and transmits the count of clicks for which the advertiser is to pay as ‘valid click count’ for corresponding advertisement to the advertisement system 100. Meanwhile, the advertiser may determine the count of clicks for which the advertiser will not pay based on ‘advertisement publication result information’ provided by the advertisement system 100, and transmits the count of clicks for which the advertiser is not to pay as ‘invalid click count’ for corresponding advertisement to the advertisement system 100.

According to the embodiment of the present invention, the advertiser can point out the invalidity of some of user clicks by comparing the user connection time shown in the system log recorded in the advertiser terminal 900 and the user click time shown in the log data provided from the advertisement system 100.

According to another embodiment of the present invention, even though the user connects to the advertiser terminal 900 through the advertisement system 100, the advertiser may recognize only the user clicks satisfying specific conditions as valid clicks. Herein, as for the cases satisfying the specific conditions, a case where a user accesses specific web documents (for example, product search result pages, payment completion pages, log-in pages, and the like) provided by the advertiser terminal 900, a case where the user terminal 800 maintains the connection with the advertiser terminal 900 during a predetermined time period or longer, or a case where the count of requests which the user terminal 800 transmits to the advertiser terminal 900 is a predetermined count or more, would be assumed.

The advertiser may measure the invalidity of selection of the advertisement based on the basic billing information provided by the advertisement system 100 according to the reference as above, and transmit the measured result to the advertisement system 100 through a predetermined interface. Herein, information on the invalidity of selection of the advertisement, as described above, may expressed in various forms such as the count or the rate of valid or invalid clicks among clicks by the user, the billing amount according to the clicks, or the like.

In addition, the advertiser may input ‘valid click count’ or ‘invalid click count’ by advertisement publication units. When the advertisement of each keyword unit is published, the advertiser may input a different ‘valid click count’ or ‘invalid click count’ with respect to the published advertisement of each keyword unit. When the advertisement of each time unit is published, the advertiser may input a different ‘valid click count’ or ‘invalid click count’ by publication periods also with respect to the same keyword.

For example, when the advertiser registers an advertisement with respect to keywords such as flower delivery, flower basket, memorial day, or the like and provides the advertisement through the advertisement system 100, the ‘valid click count’ or the ‘invalid click count’ for each keyword is differently presented even though the observed click count for the keyword of flower delivery is the same as the observed click count for the keyword of memorial day.

In addition, the advertiser may specify the period of the advertisement publication to input the ‘valid click count’ or the ‘invalid click count’. For example, when several advertisers publish advertisements with respect to the keyword of flower delivery, some advertisers may input the ‘valid click count’ or ‘invalid click count’ on a weekly basis and other advertisers may input on a monthly basis. As such, the advertisement system 100 allows the advertiser to set a target period of payment at the time of inputting the ‘valid click count’ or ‘invalid click count’, thereby giving a more high degree of freedom with respect to the time of payment for advertisement publication. It is possible to force the cyclic deadline for payment.

As such, basic self-billing information transmitted from the advertiser terminal 900 to the advertisement system 100 may include identification information on a target advertisement, information on the ‘valid click count’ or ‘invalid click count’, information on a publication period of a payment object advertisement. Information to be included the basic self-billing information may be changed into various forms according to constitution of the advertisement system 100. For example, the advertiser may input the ‘valid click count’ or ‘invalid click count’ with respect to the payment object advertisement, and may input ‘valid billing amount’ or ‘invalid billing amount’ for the ‘valid click count’ or the ‘invalid click count’ as selection information when the unit cost per click is previously set to a predetermined value.

4. Adjustment of Billing Amount

A billing determining unit 154 according to an embodiment of the present invention may reflect information on the invalidity of selection of the advertisement determined and inputted by the advertiser, according to the basic billing information calculated by the billing setting unit 152, to adjust the billing amount for the advertiser.

That is, the billing determining unit 154 may adjust the basic billing amount for the previously published advertisement based on the basic self-billing information of the advertiser received from the advertiser terminal 900. The billing for a search keyword advertisement based on the CPC model of the related art is performed based on the bid amount inputted from the advertiser before click information of users in reference to advertisement exposure and the exposure of the advertisement. This billing of the search keyword advertisement may be performed by keeping account information for the advertiser in a database and reflecting the final billing amount determined by advertisement exposure and clicking of users in advertiser account information.

The billing determining unit 154 may bill for advertisement publication by changing balance information on an advertiser account after publishing of advertisement while the account information related to the advertiser is stored in the database. However, the billing amount according to the embodiment of the present invention is determined based on the ‘valid click count’ or the ‘invalid click count’ inputted by the advertiser after publishing of the advertisement, unlike the billing for the CPC model search keyword advertisement of the related art.

As an example, the billing determining unit 154 may reduce, for example, $10,000 from the advertiser account, based on the ‘valid click count’ from the advertiser. As another example, when the advertiser publishing a banner advertisement receives the exposure count of the banner advertisement and the click count with respect to the banner advertisement from the advertisement system 100 and inputs the ‘valid click count’ of the time period of one week during which the banner advertisement is published, the billing determining unit 154 may bill for the corresponding banner advertisement by reducing $12,000 from the balance on the advertiser account.

As described in the above examples, the billing determining unit 154 may completely trust the advertiser with respect to the ‘valid click count’ or the ‘invalid click count’, and reflect it in actual billing information as it is.

In addition, according to an embodiment of the present invention, the billing determining unit 154, when the amount calculated by reflecting information on the invalidity of selection of the advertisement inputted from the advertiser in the basic billing amount is within a range of the appropriate billing reference set by the billing reference setting unit 151, may reflect information on the invalidity of selection of the corresponding advertisement in the basic billing amount.

To achieve this, the billing determining unit 154, in publishing the advertisement of each keyword unit, may set a limit of the ‘valid click count’ or ‘invalid click count’ which the advertiser can set, based on advertisement publication result information of the past of the advertiser.

As an example, the billing determining unit 154 may calculate an expected billing amount based on advertisement publication result information of the corresponding advertiser, and may decrease the uncertainty in the advertisement billing amount by setting a ‘valid click count’ or ‘invalid click count’ settable range to which the predicted billing amount pertains. The predicted billing amount may be calculated based on a weighted moving average of the past advertisement publication budget, or the like, and a weight according to a lapse of time may be considered in a calculation procedure. The weight may be designed to reflect a repetition pattern by seasons or by days of the week, or such that the recent publication budget has more influence.

As another example, the limit may be imposed in a manner that a rapid change is not allowed above a predetermined level based on a budge size of the last published advertisement.

In application of limitations on setting of the aforementioned ‘valid click count’ or ‘invalid click count’, the input of ‘valid click count’ or ‘invalid click count’ deviating from corresponding conditions may not allowed. In addition, a flexible operation is also possible in a manner that a separate authorization procedure is set while the input of the ‘valid click count’ or ‘invalid click count’ against the limitation condition is allowed.

For example, when an appropriate billing amount according to the appropriate billing reference set by the billing reference setting unit 151 with respect to a specific advertisement is 1,000,000 won to 1,200,000 won and the basic billing amount is calculated to 1,400,000 won, if a rate of invalid click inputted by the advertiser is 20%, the billing amount reflecting this point of the advertiser becomes 1,120,000 won to be within a range of the appropriate billing reference. Therefore, information on the invalidity of selection of the advertisement provided by the advertiser is accepted. However, if the rate of invalid click inputted by the advertiser is 30%, the billing amount reflecting this becomes 980,000 won to be out of a range of the appropriate billing reference. Therefore, this point of the advertiser may not be accepted. When the point of the advertiser is not accepted, the basic billing amount itself may be determined as the final billing amount, or a predetermined amount within the range of the appropriate billing reference may be determined as the final billing amount.

According to another embodiment of the present invention, the billing determining unit 154 may reflect this in the determination of the final billing amount unconditionally, while omitting a separate determining procedure with respect to information on the invalidity of advertisement selection inputted by the advertiser. For example, when the basic billing amount is 1,000,000 won and a rate of invalid click inputted by the advertiser is 30%, the final billing amount which the advertiser is billed may be 700,000 won.

Meanwhile, according to the embodiment of the present invention, when the advertisement system 100 reflects information on the invalidity of advertisement selection inputted by the advertiser as it is, some advertisers may be expected to abuse claims of invalid click. In this case, a method of imposing a penalty, such as, stopping accounts of the advertisers repeatedly abusing absurd claims of invalid click or transmitting alarm messages to the corresponding advertisers will be assumed.

5. Adjustment of Exposure Attribute

An exposure attribute adjusting unit 190 may adjust an advertisement exposure attribute of future based on the basic self-billing information (‘valid click count’ or ‘invalid click count’) of the advertiser received from the advertiser terminal 900. The exposure attribute adjusting unit 190, when the advertiser wants to continue advertisement publication also next week in reference to the same keyword, may adjust a ranking index of the corresponding keyword advertisement based on the click count according to the ‘valid click count’ or ‘invalid click count’ during the last week of advertisement publication.

The ranking index mentioned as above may be expressed by the following Equation 1 and Equation 2.

Ranking Index (RI)=Valid click count/Expected Click Count (ECC) [Equation 1]

Expected Click Count (ECC)=Expected Click Ratio (ECR) according to the aspect of advertisement exposure×click count of user generated at the time of advertisement exposure of the past. [Equation 2]

Herein, the expected click count ratio (ECR) is an expected click rate.

The ranking index by the Equation 1 may be comprehended as an index for predicting an expected unit cost per click in advertisement exposure of future. It is expected to maximize the billing amount in advertisement publication of future by arranging advertisements based on this ranking index.

For example, the ranking index of advertisement may be calculated by a function based on the amount of sales expected to be generated against publication of the corresponding advertisement. In other words, the ranking index proportion to the expected amount of sales instead of the expected unit cost per click may be applied.

As such, the ranking index may be calculated through various expected indexes related to the sales in reference to the advertisement to be exposed in the future. A weight according to the time may be applied to the advertisement publication result considered in the calculating this expected indexes.

The above ranking indexes are merely for illustration. Various ranking indexes for optimizing the sale costs of future according to advertisement publication will be induced based on the basic self-bid information, such as the ‘valid click count’ or ‘invalid click count’ inputted by the advertiser.

This ranking index may be composed of indexes about advertisement publication results. The ranking index may be calculated even without considering a quality index reflecting the relation between advertisements and advertisement exposure pages. A relevance of title and description (T&D) of advertisement, and an index about a quality of product service sold through the advertisement, that is, the quality index may be considered in the ranking index. However, it is possible to sufficiently realize an embodiment of the present invention with only one type of calculation of the ranking index excluding the quality index in order to remove the uncertainty in the calculation procedure of the quality index, which may be a problem in a relationship with the advertiser.

Meanwhile, the quality index or a performance index may be reflected through separate calculation procedures in order to calculate the ranking index. The quality index is an index quantifying the quality of the corresponding advertisement, and may be utilized as an index for estimating how effectively the advertisement attracts users.

The quality index in a keyword search advertisement may be calculated based on the expected click count with respect to the corresponding search advertisement and the valid click count according to determination of the advertiser (utility click count). In other words, the quality index may be calculated as a criterion for how many clicks are induced against the click count generally expected when the advertisement is exposed to a predetermined inventory. The present expected click count and valid click count as well as the past expected click count and valid click count may be reflected in the calculation procedure of the quality index.

The quality index may be utilized in calculation of the ranking index, together with the bid amount of the advertiser for the corresponding advertisement. In addition, the quality index may be reflected in ranking arrangement among plural advertisements as well as direct expression attributes of the advertisement.

As mentioned above, the bid amount (BA) inputted by the advertiser as well as the billing reference (valid/invalid click count) inputted by the advertiser with respect to previously published advertisement may influence the quality index. The quality index may be reflected in advertisement exposure attributes of the advertisement to be published in the future by again influencing the ranking index, and the like.

As such, the basic self-bid information inputted by the advertiser influencing the billing amount itself for the billing object advertisement as well as the advertisement to be exposed in the future, thereby preventing the advertiser from abusing an authority relating to billing which is given to the advertiser. For example, when the advertiser input a valid click count excessively lower utility that he or she receives, the quality index of advertisement of the advertiser may become worse. Since the worse quality index may have a bad influence on the future advertisement exposure attribute, the abusing of authority below self-billing can be prevented.

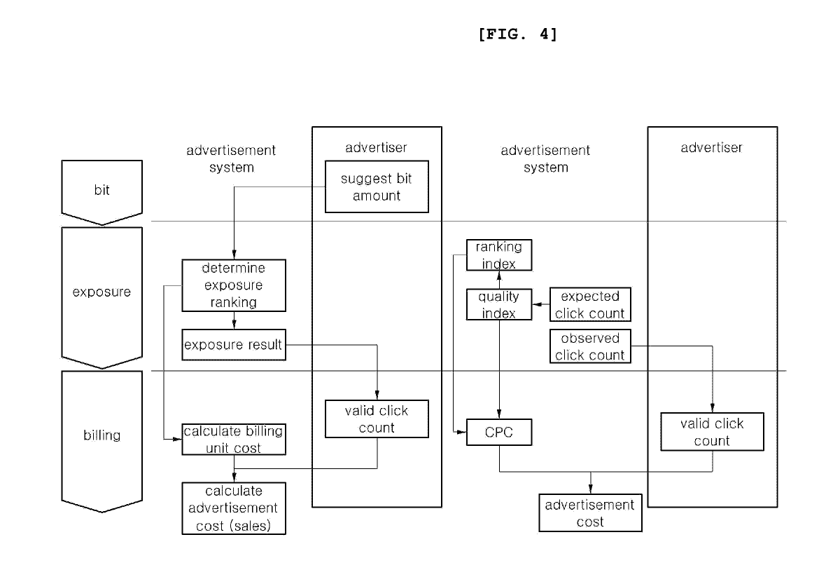

FIG. 4 is a view illustrating a participation aspect of a subject participating in an advertisement service method according to an embodiment of the present invention.

As described with reference to the above drawings, the advertisement may be provided to the user terminal 800 by sequentially performing bidding of advertisement, exposing of advertisement, and billing for the exposed advertisement, in that order.

The advertiser may transmit information needed for exposure of the advertisement to the advertisement system 100 in a bidding procedure of the advertisement. The advertiser may register the advertisement in the keyword unit, like in a general search keyword advertisement, and differently set an advertisement exposure condition in the keyword unit.

Herein, the advertiser may input the bid amount as basic data for arranging positions among plural advertisements and/or calculating the advertisement billing amount. The bid amount inputted from the advertiser before publishing of the advertisement may be used in calculation of advertisement publication cost, together with information on the invalidity of clicks inputted from the advertiser (the valid count among the observed click count) after publishing of the advertisement.

In an exposure process of the advertisement, the advertisement system 100 may determine which web page advertisement with respect to a predetermined keyword is to be exposed through. In addition, when plural advertisements compete for the same keyword, the advertisement system 100 may determine the advertisement exposure ranking among them. The advertisement exposure ranking may be determined by using a ranking index (RI) calculated by respective advertisements. The ranking index may be calculated based on the expected click count (ECC) for the advertisement to be exposed and the valid click count inputted by the advertiser. Meanwhile, the advertisement system 100 may provided advertisement publication result information (for example, an exposure result such as observed click count) as a foundation for determining the basic self-billing information (selection information) such as ‘valid click count’ or ‘invalid click count’, which is inputted by the advertiser. For this reason, the advertiser determines the valid click count.

The basic self-billing information (which may be inputted as valid click count, invalid click count, valid click ratio, or the like) may be reflected in the quality index of the corresponding advertisement. The quality index may be calculated as an index indicating a degree in attraction of customers against the expected achievement with respect to the corresponding advertisement. This quality index may be reflected in calculation of the ranking index with respect to the advertisement exposure of future.

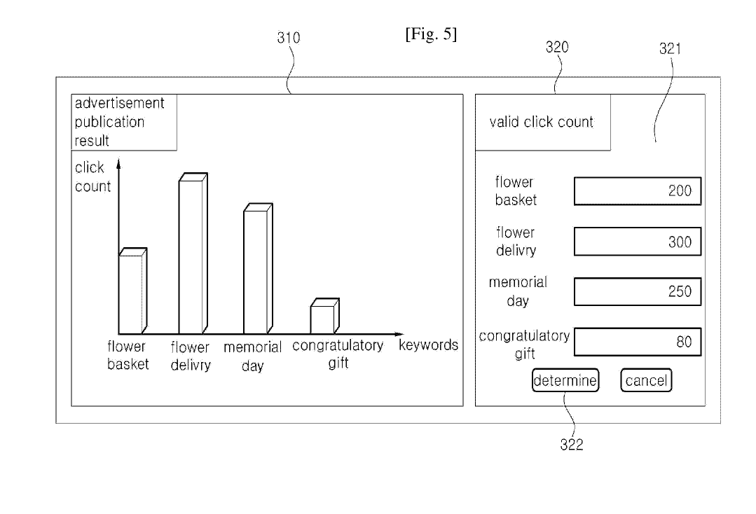

FIG. 5 shows an example of an interface provided to the advertiser through the advertiser terminal 900 according to an embodiment of the present invention. The advertiser terminal 900 may include an application program or a program module for expressing information on the advertisement publication result provided from the advertisement system 100 in the unit of click count, and, based on this, enabling the advertiser to set and present the valid click count by the keywords. The interface of FIG. 4 may be expressed by this application module or program module. This interface, of course, need not be expressed by a separate program or program module, and may be realized in a form of web page provided from the advertisement system 100.

The interface, as shown in FIG. 5, may include an advertisement publication result display window 310 by the keywords and a valid click count presentation window 320.

The count of which a user clicks on advertisement information of the advertiser on a search result page transmitted from the advertisement system 100 may be displayed by keyword on the advertisement publication result display window 310. The count of user clicks per each keyword, as shown in FIG. 4, may be expressed in a graph form, but this form of expression can be surely changed by those skilled in the art. In other words, the expression may be made in various forms of figures, tables, drawings, and the like. Information displayed on the advertisement publication result display window 310 may be information aggregated during a predetermined unit period.

Meanwhile, input windows 321 on which the advertiser is capable of inputting the self-billing amount that the advertiser-desired are provided onto the valid click count presentation window 320 by the keywords. The advertiser may input the billing amount on each of the input windows 321 thought to be appropriate based on the advertisement publication result information provided through the advertisement publication result display window 310.

Then, the advertiser may transmit information on the billing amount, that the advertiser is to present, to the advertisement system 100 by clicking on a determination button 322 included in the valid click count present window 320.

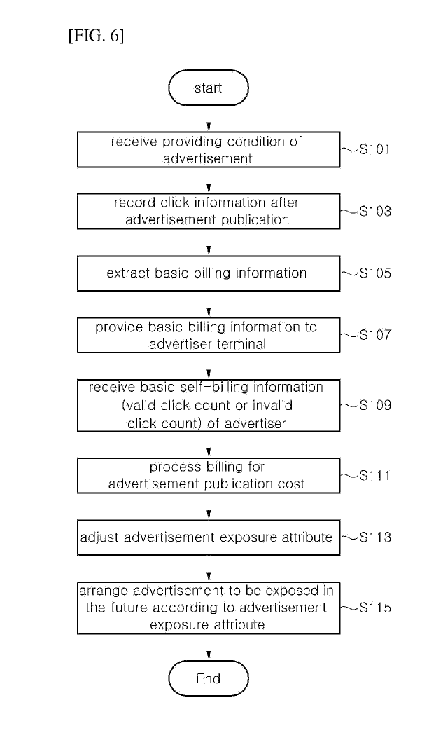

An advertisement service method of the advertisement system having this constitution will be described, with reference to FIG. 6, as follows.

FIG. 6 is an operational flowchart describing an advertisement service method of an advertisement system according to an exemplary embodiment of the present invention.

First, an advertisement system 100 receives providing conditions of advertisement including suggesting a bid amount from the advertiser terminal 900 in order to provide an advertisement service according to the keyword inputted by an internet user through a user terminal 800 (S101). Herein, the advertisement system 100 may receive information on plural keywords with respect to an advertisement which the advertiser wants to publish, and autonomously decide plural keywords considering information of the advertiser requesting publication of the advertisement, for example, business sector, scale, advertisement budget, or the like. The advertisement system 100 may receive targeting information for a user to which the advertisement is exposed, information on restriction of advertisement exposure, information on title and description (T&D) of the advertisement besides keywords with respect to the advertisement, from the advertiser.

Then, the advertisement system 100 records advertisement click information, such as clicking by the user and the like, after the user input the keyword by the user terminal 800 through which the advertisement is published (S103). Herein, a click information record is history information collected during a period of advertisement publication, and may include a procedure of grasping which movement the user receiving the advertisement through the user terminal 800 make and storing the grasped result.

After step 103, when the advertisement publication period is designated, a process of recording click information generated during the designated advertisement publication period and analyzing the corresponding click information may be performed. However, after the designated advertisement publication period, basic data about the movement of the user with respect to the previously published advertisement may be analyzed. The advertisement publication period may be designated on a daily basis, on a weekly basis, on a monthly basis, on a hourly basis, or the like, and may be designated on a minutely basis, according to the needs of the advertiser.

Then, the advertisement system 100 extracts basic billing information including the recorded click information (S105). Then, the advertisement system 100 provides information on the advertisement publication result based on the extracted basic billing information to the advertiser terminal 900 (S107). Advertisement publication result information may include various indexes such as a result of the previously published advertisement, that is, the exposure count, the observed click count, the click count by time periods, and the like, of the published advertisement.

Then, the advertisement system 100 receives the valid click count or invalid click count inputted from the advertiser terminal 900 based on the provided advertisement publication result information (S109).

Then, the advertisement system 100 requests payment processing of the advertiser terminal 900 with respect to the total billing amount for the advertisement previously published against the billing amount based on the received valid click count or invalid click count, or performs billing processing by using account information of the advertiser and the like (S111).

Herein, the billing for advertisement publication may be performed by storing account information related to the advertiser in the database 180b and changing balance information on the advertiser account after publishing of the advertisement.

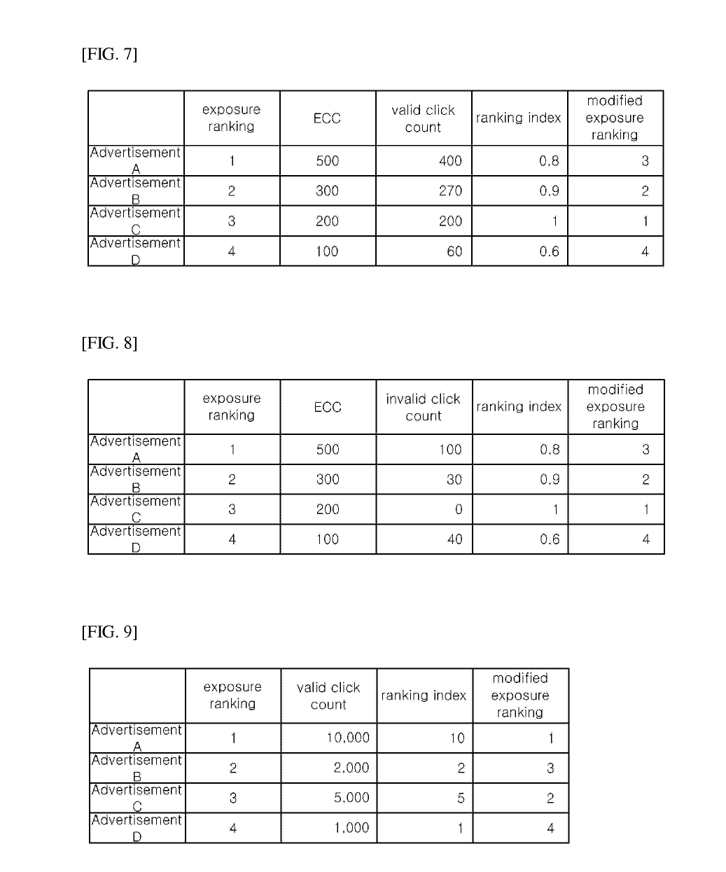

Then, the advertisement system 100 adjusts an advertisement exposure attribute based the valid click count or the total billing amount according to which payment for the previously published advertisement is processed (S113). The advertisement exposure attribute may include a ranking index of keyword advertisements based on the total billing amount of advertisement publication cost of the past. The ranking index may be calculated in proportion to the total billing amount. The ranking index may also be calculated as a value of dividing the valid click count by an expected click count (ECC) as shown in FIG. 7, a value of dividing a value of subtracting the invalid click count from the expected click count by the expected click count as shown in FIG. 8, or as a value of dividing the billing amount by a predetermined number as shown in FIG. 9.

Then, the advertisement system 100 arranges advertisements to be exposed in the future based on the calculated ranking index (S115). The advertisement system 100 provides a search result page according to the exposure attribute adjusted as above. Accordingly, when the ranking index is low, particularly, when the self-billing amount of the advertiser is low in comparison with those of other advertisements, the ranking index can deviate from the previously determined exposure ranking. Therefore, it is preferable for the advertiser to present the self-billing amount within a range of appropriate billing amount.

Although not shown in FIG. 6, the advertisement system 100 may determine whether the period of advertisement publication is expired or not, after step 115. When the period of advertisement publication is not expired, processes of publishing an advertisement of a next period of advertisement publication may be performed. When the period of advertisement publication is expired, providing of advertisement according to a providing condition of the advertiser may be realized to be ended.

Further, the advertisement system 100, when the advertiser requests replacement of the keyword, may provide, for example, an input window for replacing keywords in order to enable the replacement of the keyword, and reflect the a keyword for replacement inputted through the input window in an advertisement service.

The embodiments according to the present invention described above are realized in a form of program commands capable of being performed through various computer components to be recordable in a computer readable recording media. The computer readable recording media may include program commands, data files, data structures, or the like, alone or in combination. The program commands recorded in the recording media may designed and constituted especially for the present invention, or may be known to those skilled in a field of computer software to be usable. Examples of the computer readable recording media may include magnetic media such as hard disk, floppy disk, and magnetic tape, optical recording media such as CD-ROM, DVD, and the like, magneto-optical media such as floptical disk, and hardware devices specially constituted to store and perform program commands such as ROM, RAM, flash memory. Examples of the program commands may include machine language codes such as being made by compilers as well as high-level language codes capable of being performed by computers using interpreters or the like. The hardware device may be constituted to be operated as one more software modules in order to perform the process according to the present invention, and vise versa.

As such, the present invention is described by specific matters such as concrete components and the like, limited embodiments, and drawings. However, this is provided only for helping the entire understanding, but the present invention is not limited to the embodiments. One of ordinary skill in the art to which the present invention pertains can try various modifications and changes from this description.

Accordingly, sprits of the present invention should not be limited to the above-described embodiments, and the following claims as well as all changed equally or equivalently to the claims are intended to fall within the scopes and spirits of the invention.

1. A method for billing an advertiser for an advertisement provided on a network, the method comprising:
extracting basic billing information based on a selection history of a plurality of users for advertisement information of the advertiser;
transmitting the basic billing information to an advertiser terminal;
receiving information on invalidity of advertisement selection from the advertiser terminal;
determining a billing amount based on the received information on invalidity of advertisement selection; and
performing billing for the advertiser by applying the determined billing amount.

2. The method of claim 1, wherein the selection history of the plurality of users for the advertisement information includes the click count of the plurality of users for the advertisement information.

3. The method of claim 1, wherein the basic billing information includes at least one of a basic billing amount, click counts of the users, an advertisement cost per click, and log data according to clicks of the user.

4. The method of claim 1, wherein the information on invalidity of advertisement selection is described in a format of the count or the ratio of valid or invalid clicks of the entire clicks for the advertisement information or a billing amount according to the clicks.

5. The method of claim 1, wherein the determining of the billing amount includes unconditionally reflecting the received information on invalidity of advertisement selection.

6. The method of claim 1, wherein the determining of the billing amount includes determining the billing amount in which the received information on invalidity of advertisement selection is reflected as the final billing amount when the billing amount is in the range of a preset appropriate billing reference and determining a billing amount based on the basic billing information when the billing amount is not in the range of the preset appropriate billing reference.

7. The method of claim 1, wherein the determining of the billing amount includes determining the billing amount in which the received information on invalidity of advertisement selection is reflected as the final billing amount when the billing amount is in the range of a preset appropriate billing reference and determining a predetermined amount according to the preset appropriate billing reference as a billing amount when the billing amount is not in the range of the preset appropriate billing reference.

8. A system for billing an advertiser for an advertisement provided on a network, the system comprising:
a billing setting unit extracting basic billing information based on a selection history of a plurality of users for advertisement information of the advertiser and transmitting the basic billing information to a system of the advertiser; and
a billing determining unit determining a billing amount based on information on invalidity of advertisement selection received from the advertiser terminal.

9. The system of claim 8, wherein the selection history of the plurality of users for the advertisement information includes the click count of the plurality of users for the advertisement information.

10. The system of claim 8, wherein the basic billing information includes at least one of a basic billing amount, click counts of the users, an advertisement cost per click, and log data according to clicks of the user.

11. The system of claim 8, wherein the information on invalidity of advertisement selection is described in a format of the count or the ratio of valid or invalid clicks of the entire clicks for the advertisement information or a billing amount according to the clicks.

12. The system of claim 8, wherein the billing determining unit unconditionally reflects the received information on invalidity of advertisement selection.

13. The system of claim 8, wherein the billing determining unit determines the billing amount in which the received information on invalidity of advertisement selection is reflected as the final billing amount when the billing amount is in the range of a preset appropriate billing reference and determines a billing amount based on the basic billing information when the billing amount is not in the range of the preset appropriate billing reference.

14. The system of claim 8, wherein the billing determining unit determines the billing amount in which the received information on invalidity of advertisement selection is reflected as the final billing amount when the billing amount is in the range of a preset appropriate billing reference and determining a predetermined amount according to the preset appropriate billing reference as a billing amount when the billing amount is not in the range of the preset appropriate billing reference.

15. A computer-readable recording medium having a computer program recorded therein, the computer program executing the method of any one of claims 1 to 7.
